(19) United States
(12) Patent Application Publication
(10) Pub. No.: US 2024/0303771 A1
(43) Pub. Date: Sep. 12, 2024

(54) SUBJECT EXTRACTION DEVICE, SUBJECT EXTRACTION METHOD, AND PROGRAM

(71) Applicant: NIPPON TELEGRAPH AND TELEPHONE CORPORATION, Tokyo (JP)

(72) Inventor: Makoto MUTO, Tokyo (JP)

(73) Assignee: NIPPON TELEGRAPH AND TELEPHONE CORPORATION, Tokyo (JP)

(21) Appl. No.: 18/576,697

(22) PCT Filed: Jul. 6, 2021
(86) PCT No.: PCT/JP2021/025521

§ 371 Date: Jan. 4, 2024

(51) Int. Cl. G06T 3/4053; G06T 7/62; G06V 10/25

(52) U.S. Cl. CPC G06T 3/4053; G06T 7/62; G06V 10/25

(57) ABSTRACT

A subject extraction device (10) according to the present disclosure includes: a resolution reducing unit (111) that reduces resolution of an image to generate a low resolution image; a subject possibility extraction unit (112) that extracts possibilities of a subject portion from the low resolution image; a resolution increasing unit (113) that increases resolution of a boundary portion between the subject portion and a non-subject portion, judges whether the boundary portion is the non-subject portion pixel by pixel, and decides the subject portion and the non-subject portion on the basis of a judgement result; and a calculation resource assignment unit (114) that determines a value of the calculation resource to be assigned to the subject possibility extraction unit (112) as a first value and a value of the calculation resource to be assigned to the resolution increasing unit (113) as a second value such that the values are equal to or less than an upper limit value of the calculation resource that can be used by the subject possibility extraction unit (112) and the resolution increasing unit (113), and assigns the calculation resource to the subject possibility extraction unit (112) and the resolution increasing unit (113) on the basis of the first value and the second value that have been determined.

### TECHNICAL FIELD

The present disclosure relates to a subject extraction device, a subject extraction method, and a program.

### BACKGROUND ART

Conventionally, in order to extract a subject such as a player from a video of a sports game or the like, a portion of the subject is extracted from individual frame images constituting the video. In a scene such as public viewing in which a sports event is relayed at a remote place, a captured video needs to be processed in real time in order to convey the situation of the game to spectators in a live manner, and thus, processing time that can be allocated to processing of individual frames is limited. Specifically, for example, in the case of a video of 60 frames per second, the processing time required for one frame is 1/60 seconds. It is more difficult to correctly extract a subject from an image in such a short time as the image has higher definition. Therefore, as disclosed in Non Patent Literature 1, in the related art, processing is performed in which once the resolution is converted to a low resolution, subject extraction is performed with the image having the low resolution, whether it is a subject is determined for an unclassified region that cannot be classified as a subject or a non-subject, and finally, a subject portion having the resolution increased is extracted.

### CITATION LIST

### Non Patent Literature

Non Patent Literature 1: Hirokazu Kakinuma et al., “Real-time Extraction of Objects from Any Background Using Machine Learning”, NTT Technical Journal, Vol. 30, No. 10 (Vol. 355), pp. 16-20, October 2018

### SUMMARY OF INVENTION

### Technical Problem

However, when the unclassified region becomes large due to a large number of subjects or a complicated shape of the subject, the processing amount of determination of the unclassified region becomes relatively large, and it may be difficult to end the processing within a limited time. For example, as illustrated in FIG. 9, when the case where the number of subjects in the input image is one is compared with the case where the number of subjects in the input image is two, the area of the unclassified region generated in the case where the number of subjects is two is twice the area of the unclassified region generated in the case where the number of subjects is one, and thus, the processing amount of the determination of the unclassified region is also twice. There has been a demand for a technology of calculation resource assignment in consideration of such a change in processing amount.

An object of the present disclosure made in view of such circumstances is to provide a technology that enables highly efficient assignment of calculation resources for processing related to extraction of a subject portion.

### Solution to Problem

A subject extraction device according to the present disclosure includes: a resolution reducing unit that reduces resolution of an image to generate a low resolution image; a subject possibility extraction unit that extracts possibilities of a subject portion from the low resolution image; a resolution increasing unit that increases resolution of a boundary portion between the subject portion and a non-subject portion among the possibilities of the subject portion, judges whether the boundary portion is the non-subject portion pixel by pixel, and decides the subject portion and the non-subject portion on the basis of a judgement result; and a calculation resource assignment unit that acquires an upper limit value of a calculation resource that can be used by the subject possibility extraction unit and the resolution increasing unit, determines a value of the calculation resource to be assigned to the subject possibility extraction unit as a first value and a value of the calculation resource to be assigned to the resolution increasing unit as a second value such that the values are equal to or less than the upper limit value that has been acquired, and assigns the calculation resource to the subject possibility extraction unit and the resolution increasing unit on the basis of the first value and the second value that have been determined.

A subject extraction method according to the present disclosure is a subject extraction method performed by a subject extraction device, the method including: a resolution reducing step of reducing resolution of an image to generate a low resolution image; a subject possibility extraction step of extracting possibilities of a subject portion from the low resolution image; a resolution increasing step of increasing resolution of a boundary portion between the subject portion and a non-subject portion among the possibilities of the subject portion, judging whether the boundary portion is the non-subject portion pixel by pixel, and deciding the subject portion and the non-subject portion on the basis of a judgement result; and a calculation resource assignment step of acquiring an upper limit value of a calculation resource that can be used by the subject possibility extraction step and the resolution increasing step, determining a value of the calculation resource to be assigned to the subject possibility extraction step as a first value and a value of the calculation resource to be assigned to the resolution increasing step as a second value such that the values are equal to or less than the upper limit value that has been acquired, and assigning the calculation resource to the subject possibility extraction step and the resolution increasing step on the basis of the first value and the second value that have been determined.

Furthermore, a program according to the present disclosure causes a computer to function as the subject extraction device according to the present disclosure.

### Advantageous Effects of Invention

According to the present disclosure, it is possible to provide a technology that enables highly efficient assignment of calculation resources for processing related to extraction of a subject portion.

### BRIEF DESCRIPTION OF DRAWINGS

FIG. 1 is a diagram illustrating an example of a configuration of a subject extraction device according to an embodiment of the present disclosure.

FIG. 2A is a diagram for explaining a flow of processing of extracting a subject.

FIG. 2B is a diagram for explaining a flow of processing of extracting a subject.

FIG. 2C is a diagram for explaining a flow of processing of extracting a subject.

FIG. 2D is a diagram for explaining a flow of processing of extracting a subject.

FIG. 2E is a diagram for explaining a flow of processing of extracting a subject.

FIG. 2F is a diagram for explaining a flow of processing of extracting a subject.

FIG. 3 is a diagram illustrating an example of a result of assigning a calculation resource.

FIG. 4 is a diagram illustrating operation of a subject extraction device according to an embodiment of the present disclosure.

FIG. 5 is a diagram illustrating an example of a configuration of a subject extraction device according to a first modification.

FIG. 6 is a diagram illustrating operation of the subject extraction device according to the first modification.

FIG. 7 is a diagram illustrating an example of a configuration of a subject extraction device according to a second modification.

FIG. 8 is a diagram illustrating operation of the subject extraction device according to the second modification.

FIG. 9 is a diagram for explaining a conventional subject extraction technique.

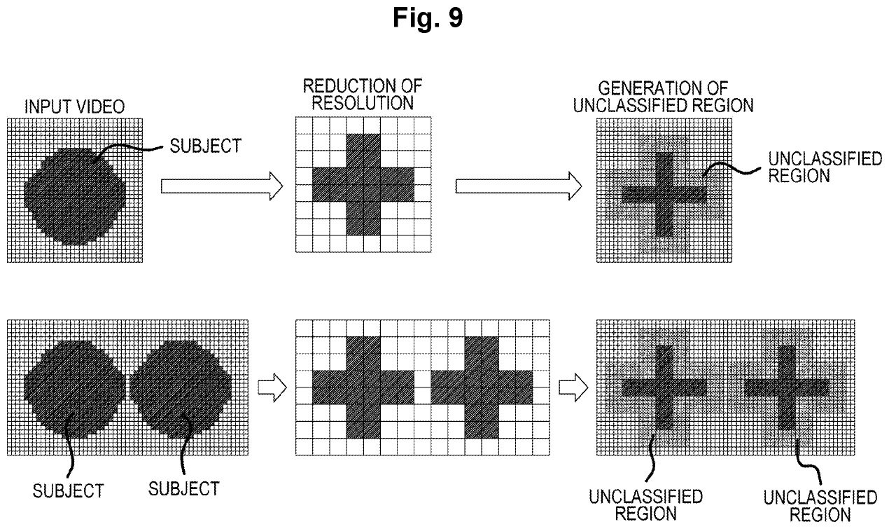

### DESCRIPTION OF EMBODIMENTS

Hereinafter, embodiments of the present disclosure will be described with reference to the drawings as appropriate. In the drawings, the same or corresponding parts will be denoted by the same reference signs. In description of the embodiments, description of the same or corresponding parts will be omitted or simplified as appropriate. The embodiments described below are examples of a configuration of the present disclosure, and the present invention is not limited to the following embodiments.

### <Configuration of Subject Extraction Device 10>

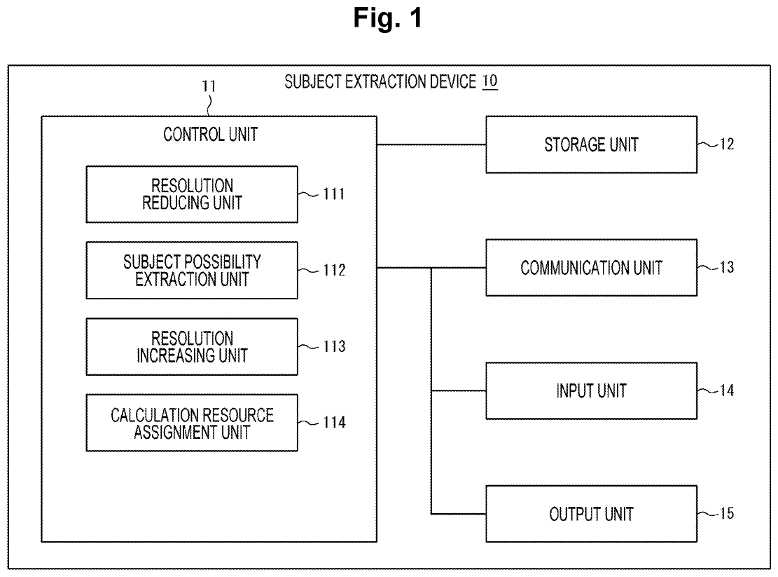

An example of a configuration of a subject extraction device 10 according to the present embodiment will be described with reference to FIGS. 1 to 4. As illustrated in FIG. 1, the subject extraction device 10 includes a control unit 11, a storage unit 12, a communication unit 13, an input unit 14, and an output unit 15.

The storage unit 12 includes one or more memories, and may include, for example, a semiconductor memory, a magnetic memory, an optical memory, or the like. Each memory included in the storage unit 12 may function as, for example, a main storage device, an auxiliary storage device, or a cache memory. The storage unit 12 stores arbitrary information used for the operation of the subject extraction device 10. The storage unit 12 is not necessarily provided inside the subject extraction device 10, and may be provided outside the subject extraction device 10.

The communication unit 13 includes at least one communication interface. The communication interface is, for example, a LAN interface. The communication unit 13 receives information used for the operation of the subject extraction device 10 and transmits information obtained by the operation of the subject extraction device 10.

The communication unit 13 enables the subject extraction device 10 to transmit and receive information to and from other devices via a network. The network includes the Internet, at least one wide area network (WAN), at least one metropolitan area network (MAN), or a combination thereof. The network may include at least one wireless network, at least one optical network, or a combination thereof. The wireless network is, for example, an ad hoc network, a cellular network, a wireless local area network (LAN), a satellite communication network, or a terrestrial microwave network.

The input unit 14 includes at least one input interface. The input interface is, for example, a physical key, a capacitance key, a pointing device, a touch screen provided integrally with a display, or a microphone. The input unit 14 receives an operation of inputting information used for the operation of the subject extraction device 10. The input unit 14 may be connected to the subject extraction device 10 as an external input device instead of being provided in the subject extraction device 10. As the connection method, for example, any method such as universal serial bus (USB), high-definition multimedia interface (HDMI) (registered trademark), or Bluetooth (registered trademark) can be used.

The input unit 14 receives an input of image data. The image data is, for example, an image capturing a sports game such as badminton, but is not limited thereto, and may be any image including a subject and a non-subject.

The output unit 15 includes at least one output interface. The output interface is, for example, a display or a speaker. The display is, for example, a liquid crystal display (LCD) or an organic electro luminescence (EL) display. The output unit 15 may include a device that can be worn by the user, such as VR goggles. The output unit 15 outputs information obtained by the operation of the subject extraction device 10. The output unit 15 may be connected to the subject extraction device 10 as an external output device instead of being provided in the subject extraction device 10. As the connection method, for example, any method such as USB, HDMI (registered trademark), or Bluetooth (registered trademark) can be used.

The control unit 11 is realized by a control arithmetic circuit (controller). The control arithmetic circuit may be constituted by dedicated hardware such as an application specific integrated circuit (ASIC) or a field-programmable gate array (FPGA), may be constituted by a processor, or may include both dedicated hardware and a processor. The control unit 11 executes processing related to the operation of the subject extraction device 10 while controlling each unit of the subject extraction device 10. The control unit 11 can transmit and receive information to and from an external device via the communication unit 13 and a network.

The control unit 11 includes a resolution reducing unit 111, a subject possibility extraction unit 112, a resolution increasing unit 113, and a calculation resource assignment unit 114.

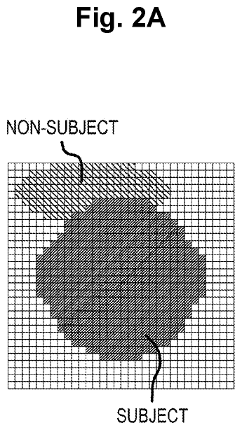

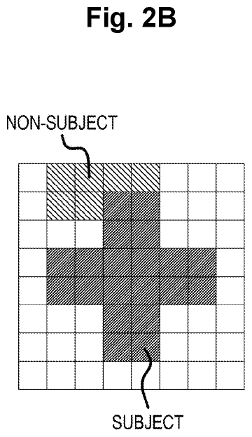

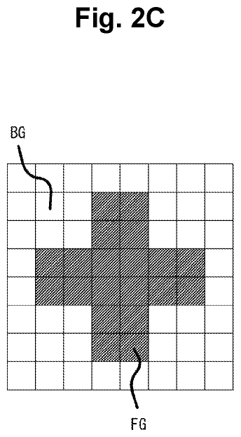

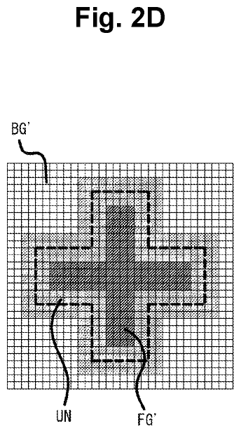

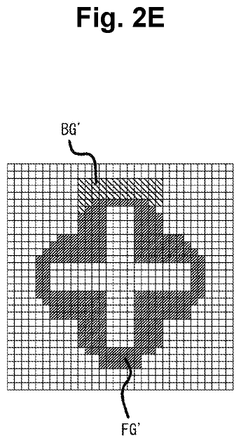

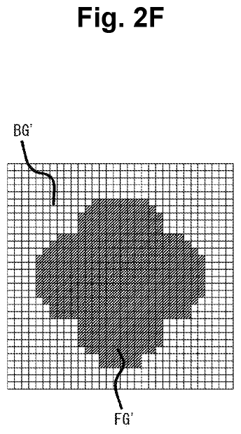

The control unit 11 acquires an image in which a subject and a non-subject appear. Image acquisition may be performed by any method. FIG. 2A is a diagram illustrating an example of an image acquired by the control unit 11. FIG. 2A is an image corresponding to one frame of a video showing a court of one team in a badminton singles game as an example, and a subject is one player. For example, in a case where the input image is a video of a badminton double game, the subjects are two players. In the input image of FIG. 2A, a subject and a non-subject are simply illustrated. The squares in FIG. 2A indicate pixels. The control unit 11 outputs the acquired image to the resolution reducing unit 111.

The resolution reducing unit 111 reduces the resolution of the image to generate a low resolution image. FIG. 2B is an example of a low resolution image generated by reducing the resolution of the input image in FIG. 2A. In FIG. 2B, it can be seen that the vertical resolution and the horizontal resolution of the input image in FIG. 2A are reduced to ¼, and the resolutions of the subject and the non-subject are reduced. The resolution reducing unit 111 outputs the generated low resolution image to the subject possibility extraction unit 112.

The subject possibility extraction unit 112 extracts a possibility FG of the subject portion from the low resolution image. Further, the subject possibility extraction unit 112 extracts a possibility other than the possibility FG of the subject portion as a possibility BG of the non-subject portion. Extraction of the possibility FG of the subject portion and the possibility BG of the non-subject portion may be performed by machine learning including deep learning. In this case, the subject possibility extraction unit 112 reads the learned model from the storage unit 12 or applies the learned model to the low resolution image. The subject possibility extraction unit 112 may receive and apply a trained model from an external device via the communication unit 13. The extraction result by the subject possibility extraction unit 112 may be displayed to the user via the output unit 15, and the user may correct the extraction via the input unit 14. The subject possibility extraction unit 112 may be able to update the learning model according to the correction.

As illustrated in FIG. 2C, the subject possibility extraction unit 112 extracts the possibility FG of the subject portion and the possibility BG of the non-subject portion from the low resolution image of FIG. 2B. Referring to FIG. 2C, it can be seen that the non-subject in FIG. 2B is extracted as a part of the possibility BG of the non-subject portion. The subject possibility extraction unit 112 outputs a low resolution image including the extracted result to the resolution increasing unit 113.

The resolution increasing unit 113 increases the resolution of the low resolution image and generates a boundary portion UN between the subject portion and the non-subject portion from at least a part of the possibility FG of the subject portion. FIG. 2D illustrates an image having its resolution increased by the resolution increasing unit 113. In FIG. 2D, the range of the possibility FG of the subject portion extracted by the subject possibility extraction unit 112 is indicated by a broken line.

First, the resolution increasing unit 113 specifies a predetermined region in the possibility FG of the subject portion as a subject portion FG′. The region to be the subject portion FG′ may be specified by a known method. For example, the resolution increasing unit 113 may specify, as the subject portion FG′, an existing region inside a predetermined distance from the range of the possibility FG of the subject portion. In FIG. 2D, a central cross-shaped region indicates a region specified as the subject portion FG′ by the resolution increasing unit 113. As can be seen from FIG. 2D, a region located on the inner side by two pixels from the range of the possibility FG of the subject portion is specified as the subject portion FG′.

Further, the resolution increasing unit 113 generates a region having a width of a certain number of pixels around the range of the possibility FG of the subject portion as the boundary portion UN. The resolution increasing unit 113 generates a region having a width of four pixels along the broken line centered on the broken line as the boundary portion UN. As described above, the resolution increasing unit 113 increases the resolution of the boundary portion UN between the subject portion and the non-subject portion.

The resolution increasing unit 113 specifies a region other than the subject portion FG′ and the boundary portion UN as a non-subject portion BG′.

The resolution increasing unit 113 judges whether the generated boundary portion UN is the subject portion FG′ pixel by pixel, and decides the subject portion FG′ and the non-subject portion BG′ on the basis of the judgement result. In this example, judgement is made pixel by pixel for the boundary portion UN illustrated in FIG. 2D. As a judgement method, a nearest neighbor search method may be employed. Specifically, the resolution increasing unit 113 selects an arbitrary pixel P1 of the boundary portion UN, searches for a pixel in a region specified as the subject portion FG′ that is closest to the pixel P1, and acquires an arbitrary value such as a luminance value and an RGB value of each of the two pixels. When the difference between the values is equal to or less than a certain threshold, the resolution increasing unit 113 specifies the pixel P1 as the subject portion FG′. In addition, the resolution increasing unit 113 selects an arbitrary pixel P2 of the boundary portion UN, searches for a pixel in a region specified as the non-subject portion BG′ that is closest to the pixel P2, and acquires an arbitrary value such as a luminance value and an RGB value of each of the two pixels. When the difference between the values is equal to or less than a certain threshold, the resolution increasing unit 113 specifies the pixel P2 as the non-subject portion BG′.

FIG. 2E illustrates a result of judging whether the resolution increasing unit 113 is the subject portion FG′ or the non-subject portion BG′ for each pixel of the boundary portion UN. Referring to FIG. 2E, it can be seen that the upper portion of the boundary portion UN in FIG. 2D is judged as the non-subject portion BG′.

The resolution increasing unit 113 adds the pixels judged as described above to each of the specified regions of the subject portion FG′ and the non-subject portion BG′ to decide the subject portion FG′ and the non-subject portion BG′. FIG. 2F illustrates the decided subject portion FG′ and non-subject portion BG′. The resolution increasing unit 113 stores the image including the subject portion FG′ and the non-subject portion BG′ in the storage unit 12. The resolution increasing unit 113 may store the image including only the subject portion FG′ in the storage unit 12.

In the above description, an example has been described in which the resolution increasing unit 113 increases the resolution of the entire low resolution image and finally outputs an image including the subject portion FG′ and the non-subject portion BG′, but the processing of the resolution increasing unit 113 is not limited thereto. The resolution increasing unit 113 may increase the resolution only in the range of the possibility FG of the subject portion in the image with the reduced resolution. In this case, the resolution increasing unit 113 specifies a region within a predetermined distance from the range of the possibility FG of the subject portion as the subject portion FG′, and judges whether each pixel of the region of the possibility FG of the remaining subject portion is included in the subject portion FG′. The resolution increasing unit 113 adds the pixel judged to be included in the subject portion FG′ to the specified subject portion FG′, and decides the portion as the subject portion FG′. The resolution increasing unit 113 may output the image including only the subject portion FG′ decided as described above.

The calculation resource assignment unit 114 acquires an upper limit value of the calculation resources that can be used by the subject possibility extraction unit 112 and the resolution increasing unit 113. The calculation resource includes a CPU, a memory, or the like of the subject extraction device 10, and the upper limit value refers to the free capacity of these. Acquisition of the upper limit value may be performed by any method. The calculation resource assignment unit 114 may acquire the upper limit value of the free capacity by constantly monitoring and predicting the use amount of the calculation resource. For example, it is assumed that the upper limit value acquired by the calculation resource assignment unit 114 is a value of 4.

Next, the calculation resource assignment unit 114 acquires information indicating the number of subject portions. The information indicating the number of subject portions may be acquired by any method. The calculation resource assignment unit 114 may acquire information indicating the number of subject portions input by the user via the input unit 14. For example, when the input video is a badminton singles game, the user inputs the number of subjects as 1, and when the input video is a badminton doubles game, the user inputs the number of subjects as 2. The calculation resource assignment unit 114 acquires the value as information indicating the number of subject portions.

The calculation resource assignment unit 114 determines the value of the calculation resource to be assigned to the resolution increasing unit 113 as the second value according to the acquired information indicating the number of subject portions. Here, the calculation resource assignment unit 114 determines the second value so as to be equal to or less than the acquired upper limit value.

The calculation resource assignment unit 114 may determine the second value by increasing the second value as the number of subject portions increases. In this example, the calculation resource assignment unit 114 determines a value proportional to the number of subject portions as the second value. Specifically, the calculation resource assignment unit 114 determines 1 as the second value when the acquired number of subject portions is 1, and determines 2 as the second value when the acquired number of subject portions is 2. As described above, the calculation resource assignment unit 114 determines the number less than 4 of the acquired upper limit value as the second value.

The calculation resource assignment unit 114 acquires a value of a calculation resource to be assigned to the subject possibility extraction unit 112. The calculation resource assignment unit 114 determines, as the first value to be assigned to the subject possibility extraction unit 112, a value obtained by subtracting the above-described second value from the acquired upper limit value. For example, when the acquired upper limit value is 4 and the second value is 1, the calculation resource assignment unit 114 determines a value of 3 as the first value.

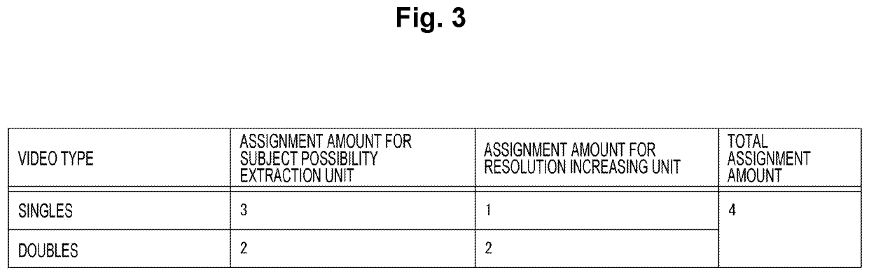

The calculation resource assignment unit 114 assigns calculation resources to the subject possibility extraction unit 112 and the resolution increasing unit 113 on the basis of the determined first value and second value. FIG. 3 illustrates an example of a result of assignment of the calculation resources by the calculation resource assignment unit 114 for each type of singles' video image in which the number of subject portions is one and doubles' video image in which the number of subject portions is two.

Referring to FIG. 3, the total assignment amount is a value of 4 as the upper limit value of the calculation resources that can be used by the subject possibility extraction unit 112 and the resolution increasing unit 113. As a value obtained by subtracting the second value to be assigned to the resolution increasing unit 113 from the upper limit value, a value of 3 for a singles' image and a value of 2 for a doubles' image are set as the first values to be assigned to the subject possibility extraction unit 112. According to the assignment of the calculation resources as illustrated in FIG. 3, the processing speed of the subject possibility extraction unit 112 decreases in the doubles' image, but the decrease in speed is only ⅔ of the singles' image. This indicates that the decrease in the processing speed as a whole is smaller considering that the processing amount of the judgement of the boundary portion UN by the resolution increasing unit 113 is twice as large as that of the singles' image in the doubles' image.

In a conventional case, when the upper limit value of the available calculation resources is 4, for example, values shown in Table 1 below are set as values of the calculation resources to be assigned to the subject possibility extraction unit 112 and the resolution increasing unit 113.

TABLE 1

| | ASSIGNMENT | ASSIGNMENT | |
|---|---|---|---|
| | AMOUNT FOR | AMOUNT FOR | TOTAL |
| | SUBJECT | RESOLUTION | ASSIGN- |
| VIDEO | POSSIBILITY | INCREASING | MENT |
| TYPE | EXTRACTION UNIT | UNIT | AMOUNT |
| SINGLES | 2 | 2 | 4 |
| DOUBLES | 2 | 2 | 4 |

As illustrated in Table 1, in a conventional case, the value of the calculation resource to be assigned is fixedly set. According to the present embodiment, the calculation resource assignment unit 114 can dynamically determine the values of the calculation resources to be assigned to the subject possibility extraction unit 112 and the resolution increasing unit 113 separately in accordance with the video type. Therefore, more efficient use of the calculation resources can be achieved.

The calculation resource assignment unit 114 may store the result in the storage unit 12 as the calculation resource assignment information. The control unit 11 may be able to read the calculation resource assignment information from the storage unit 12 in response to the request of the user and display the calculation resource assignment information to the user via the output unit 15 by voice or image.

The calculation resource assignment unit 114 may acquire information indicating a preset first value or second value, and assign a calculation resource to the subject possibility extraction unit 112 and the resolution increasing unit 113 according to the information. The information may be input by the user via the input unit 14 or may be acquired from an external device via the communication unit 13.

The calculation resource assignment unit 114 may be included in another device that can communicate with the subject extraction device 10 via a network. In this case, the calculation resource assignment unit 114 can determine the value of the calculation resource to be assigned to each of the subject possibility extraction unit 112 and the resolution increasing unit 113 for a plurality of different subject extraction devices 10.

### <Program>

In order to function as the above-described subject extraction device 10, it is also possible to use a computer capable of executing a program instruction. Here, the computer may be a general-purpose computer, a dedicated computer, a workstation, a personal computer (PC), an electronic note pad, or the like. The program instruction may be a program code, a code segment, or the like for executing required tasks.

A computer includes a processor, a storage unit, an input unit, an output unit, and a communication interface. The processor is a central processing unit (CPU), a micro processing unit (MPU), a graphics processing unit (GPU), a digital signal processor (DSP), a system on a chip (SoC), or the like and may be constituted by a plurality of processors of the same type or different types. The processor reads and executes the program from the storage unit to perform control of each of the above-described configurations and various types of arithmetic processing. Note that at least a part of these processing contents may be realized by hardware. The input unit is an input interface that receives a user's input operation and acquires information based on the user's operation, and is a pointing device, a keyboard, a mouse, or the like. The output unit is an output interface that outputs information, and is a display, a speaker, or the like. The communication interface is an interface for communicating with an external device.

The program may be recorded in a computer-readable recording medium. When such a recording medium is used, the program can be installed in the computer. Here, the recording medium on which the program is recorded may be a non-transitory recording medium. The non-transitory recording medium is not particularly limited, but may be, for example, a CD-ROM, a DVD-ROM, a USB memory, or the like. The program may be downloaded from an external device via a network.

### <Operation of Subject Extraction Device 10>

An operation of the subject extraction device 10 according to the present embodiment will be described with reference to FIGS. 2, 3 and 4. The operation of the subject extraction device 10 corresponds to the subject extraction method according to the present embodiment.

In step S1, the control unit 11 acquires an image in which a subject and a non-subject appear. Image acquisition may be performed by any method. FIG. 2A is a diagram illustrating an example of an image acquired by the control unit 11. The control unit 11 outputs the acquired image to the resolution reducing unit 111.

In step S2, the resolution reducing unit 111 reduces the resolution of the image to generate a low resolution image. FIG. 2B is an example of a low resolution image generated by reducing the resolution of the input image in FIG. 2A. The resolution reducing unit 111 outputs the generated low resolution image to the subject possibility extraction unit 112.

In step S3, the calculation resource assignment unit 114 acquires an upper limit value of the calculation resources that can be used by the subject possibility extraction unit 112 and the resolution increasing unit 113. Acquisition of the upper limit value may be performed by any method.

In step S4, the calculation resource assignment unit 114 acquires information indicating the number of subject portions. The information indicating the number of subject portions may be acquired by any method. In this example, the calculation resource assignment unit 114 acquires information indicating the number of subject portions input by the user via the input unit 24. In this example, the calculation resource assignment unit 114 acquires the value “1” as information indicating the number of subject portions.

In step S5, the calculation resource assignment unit 114 determines the value of the calculation resource to be assigned to the resolution increasing unit 113 as the second value according to the acquired information indicating the number of subject portions. The calculation resource assignment unit 114 may determine the second value by increasing the second value as the number of subject portions increases. In this example, the calculation resource assignment unit 114 determines a value proportional to the number of subject portions as the second value. In this example, the number of subject portions acquired in step S4 is one. The calculation resource assignment unit 114 determines the value “1” as the second value.

In step S6, the calculation resource assignment unit 114 determines a value of a calculation resource to be assigned to the subject possibility extraction unit 112 as the first value. The calculation resource assignment unit 114 determines, as the first value, a value obtained by subtracting the above-described second value from the acquired upper limit value as the value assigned to the subject possibility extraction unit 112.

In step S7, the calculation resource assignment unit 114 assigns calculation resources to the subject possibility extraction unit 112 and the resolution increasing unit 113 on the basis of the determined first value and second value.

In step S8, the subject possibility extraction unit 112 extracts a possibility FG of the subject portion from the low resolution image. Further, the subject possibility extraction unit 112 extracts a possibility other than the possibility FG of the subject portion as a possibility BG of the non-subject portion. Extraction of the possibility FG of the subject portion and the possibility BG of the non-subject portion may be performed by machine learning including deep learning. In this case, the subject possibility extraction unit 112 reads the learned model from the storage unit 12 or applies the learned model to the low resolution image.

As illustrated in FIG. 2C, the subject possibility extraction unit 112 extracts the possibility FG of the subject portion and the possibility BG of the non-subject portion from the low resolution image of FIG. 2B. The subject possibility extraction unit 112 outputs a low resolution image including the extracted result to the resolution increasing unit 113.

In step S9, the resolution increasing unit 113 increases the resolution of the low resolution image and generates a boundary portion UN between the subject portion and the non-subject portion from at least a part of the possibility FG of the subject portion. FIG. 2D illustrates an image having its resolution increased by the resolution increasing unit 113. In FIG. 2D, the range of the possibility FG of the subject portion extracted in step S7 is indicated by a broken line.

First, the resolution increasing unit 113 specifies a predetermined region in the possibility FG of the subject portion as a subject portion FG′. The region to be the subject portion FG′ may be specified by a known method. For example, the resolution increasing unit 113 may specify, as the subject portion FG′, an existing region inside a predetermined distance from the range of the possibility FG of the subject portion. In FIG. 2D, a central cross-shaped region indicates a region specified as the subject portion FG′ by the resolution increasing unit 113.

Further, the resolution increasing unit 113 generates a region having a width of a certain number of pixels around the range of the possibility FG of the subject portion as the boundary portion UN. The resolution increasing unit 113 generates a region having a width of four pixels along the broken line centered on the broken line as the boundary portion UN. As described above, the resolution increasing unit 113 increases the resolution of the boundary portion UN between the subject portion and the non-subject portion.

The resolution increasing unit 113 specifies a region other than the subject portion FG′ and the boundary portion UN as a non-subject portion BG′.

In step S10, the resolution increasing unit 113 judges whether the generated boundary portion UN is the subject portion FG′ pixel by pixel, and decides the subject portion FG′ and the non-subject portion BG′ on the basis of the judgement result. In this example, judgement is made pixel by pixel for the boundary portion UN illustrated in FIG. 2D. As a judgement method, a nearest neighbor search method may be employed.

FIG. 2E illustrates a result of judging whether the resolution increasing unit 113 is the subject portion FG′ or the non-subject portion BG′ for each pixel of the boundary portion UN.

The resolution increasing unit 113 adds the pixels judged as described above to each of the regions of the subject portion FG′ and the non-subject portion BG′ that have been specified in step S9 to decide the subject portion FG′ and the non-subject portion BG′. FIG. 2F illustrates the decided subject portion FG′ and non-subject portion BG′.

In step S11, the resolution increasing unit 113 stores the image including the subject portion FG′ and the non-subject portion BG′ in the storage unit 12. The resolution increasing unit 113 may store the image including only the subject portion FG′ in the storage unit 12.

In step S12, the control unit 11 reads the image from the storage unit 12 and displays the image to the user. Thereafter, the operation of the subject extraction device 10 ends.

Any method may be adopted for the display to the user. For example, the control unit 11 displays an image to the user via the output unit 15. For example, the control unit 11 may communicate with a terminal device used by the user via the communication unit 13 and transmit an image to the terminal device. Here, the terminal device includes a mobile device such as a mobile phone, a smartphone, a wearable device, or a tablet, or a PC. The “wearable device” is specifically a mobile device that can be worn on the user's body, such as VR goggles. When the terminal device receives and outputs the image, the image is displayed to the user.

As described above, the subject extraction device 10 according to the present embodiment includes: a resolution reducing unit 111 that reduces resolution of an image to generate a low resolution image; a subject possibility extraction unit 112 that extracts possibilities of a subject portion from the low resolution image; a resolution increasing unit 113 that increases resolution of a boundary portion UN between the subject portion and a non-subject portion among the possibilities of the subject portion, judges whether the boundary portion UN is the non-subject portion pixel by pixel, and decides the subject portion and the non-subject portion on the basis of a judgement result; and a calculation resource assignment unit 114 that acquires an upper limit value of a calculation resource that can be used by the subject possibility extraction unit 112 and the resolution increasing unit 113, determines a value of the calculation resource to be assigned to the subject possibility extraction unit 112 as a first value and a value of the calculation resource to be assigned to the resolution increasing unit 113 as a second value such that the values are equal to or less than the upper limit value that has been acquired, and assigns the calculation resource to the subject possibility extraction unit 112 and the resolution increasing unit 113 on the basis of the first value and the second value that have been determined.

According to the present embodiment, the subject possibility extraction unit 112 performs the process of extracting the subject portion with the image with the reduced resolution, and the resolution increasing unit 113 performs the process of judging whether it is the subject portion, only for the boundary portion UN. By using such a combination of the subject possibility extraction unit 112 and the resolution increasing unit 113, the range of the subject portion in the image can be decided at high speed. The calculation resource assignment unit 114 can designate the calculation resources to be assigned to the subject possibility extraction unit 112 and the resolution increasing unit 113 according to the number, size, and complexity of subjects included in the input image according to the number of calculation resources necessary for the processing of the boundary portion UN. As described above, it is possible to provide a technology that enables highly efficient assignment of calculation resources for processing related to extraction of a subject portion.

Although the present disclosure has been described based on the drawings and embodiments, it should be noted that those skilled in the art can easily make various modifications and amendments based on the present disclosure. Therefore, it should be noted that these modifications and amendments are included in the scope of the present disclosure.

### First Modification

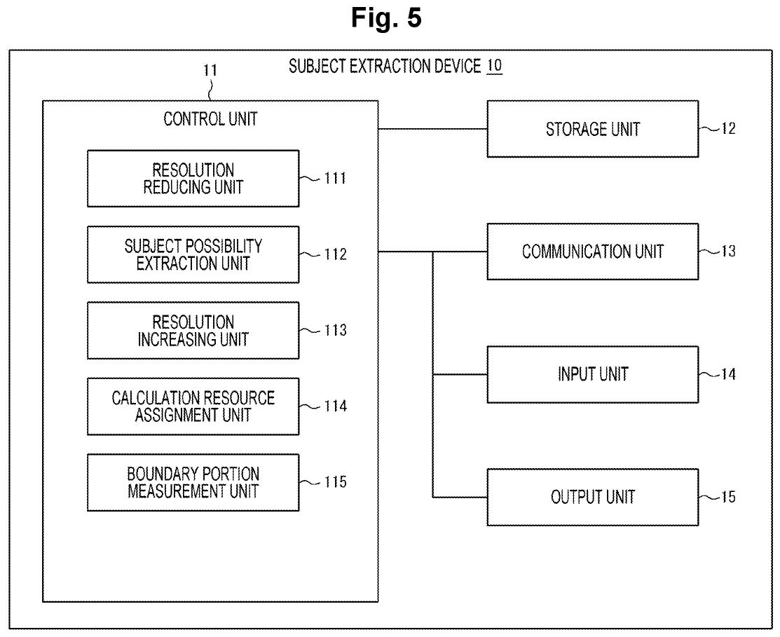

Next, a first modification of the embodiment of the present disclosure will be described. As illustrated in FIG. 5, in the present modification, the control unit 11 further includes a boundary portion measurement unit 115.

In the subject extraction device 10 of the present modification, after the resolution increasing unit 113 generates the boundary portion UN, the boundary portion measurement unit 115 measures the area of the boundary portion UN. The boundary portion measurement unit 115 outputs the measured area of the boundary portion UN to the calculation resource assignment unit 114.

The calculation resource assignment unit 114 further determines the value of the calculation resource to be assigned to the resolution increasing unit 113 as the second value on the basis of the area of the boundary portion UN.

The calculation resource assignment unit 114 may correct the second value determined according to the information indicating the number of subject portions to the second value determined according to the area of the boundary portion UN.

It is assumed that a calculation resource having a preset value is assigned to the resolution increasing unit 113, and the resolution increasing unit 113 generates the boundary portion UN. In this case, the second value described in the present modification may be determined instead of the second value of the above-described embodiment.

The calculation resource assignment unit 114 may determine the second value by increasing the second value as the measured area of the boundary portion UN is larger. For example, the calculation resource assignment unit 114 determines, as the second value to be assigned to the resolution increasing unit 113, the value “1” when the area of the boundary portion UN measured by the boundary portion measurement unit 115 is 100, and the value “2” when the area of the boundary portion UN is 200. As described above, the calculation resource assignment unit 114 may determine a value of 1/100 of the area of the boundary portion UN as the second value. As described above, the calculation resource assignment unit 114 may determine the second value according to the measured area ratio of the boundary portion UN.

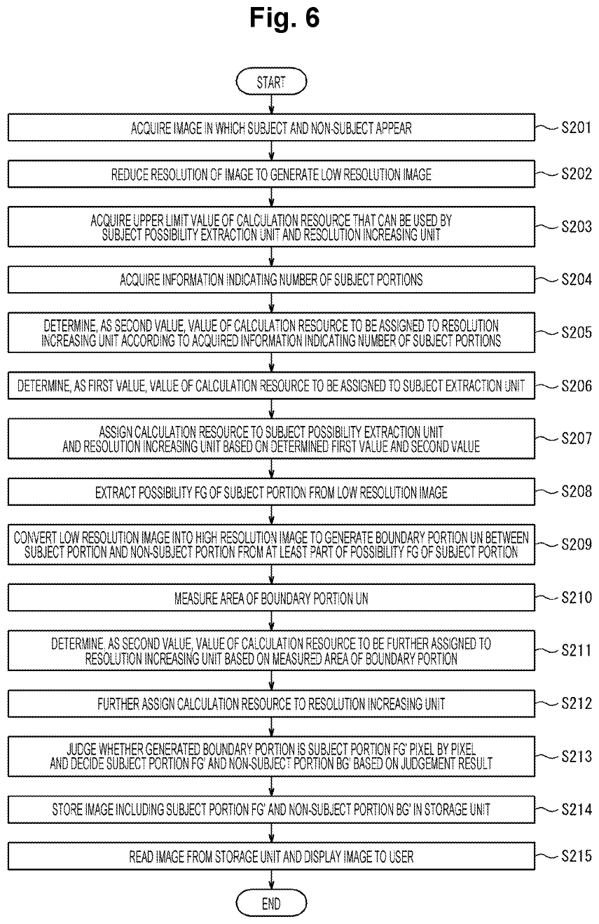

Hereinafter, a difference between the operation of the subject extraction device 10 according to the above-described embodiment and the operation of the subject extraction device 10 according to the present modification will be described with reference to FIG. 6.

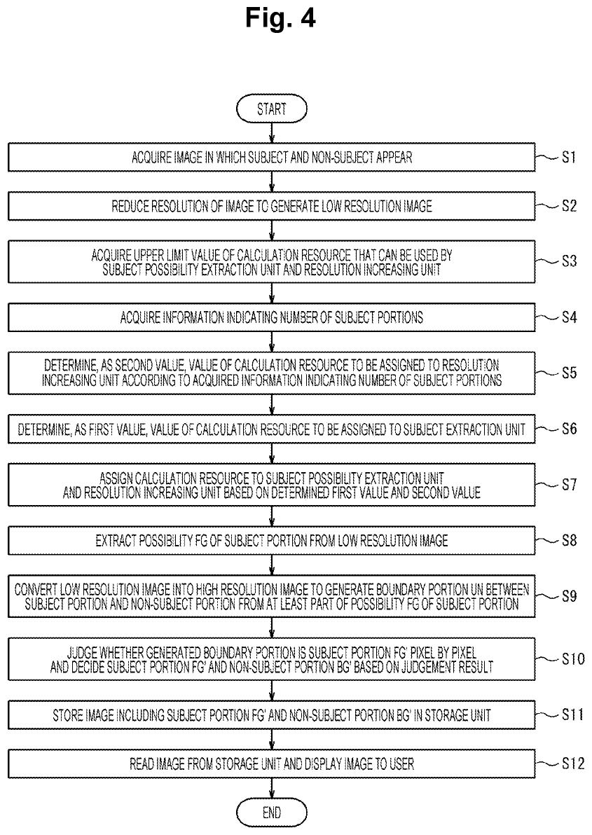

Since steps S201 to S209 in FIG. 6 are respectively the same as steps S1 to S9 in FIG. 4 according to the above-described embodiment, description will be omitted here.

In step S210, the boundary portion measurement unit 115 measures the area of the boundary portion UN. The boundary portion measurement unit 115 outputs the measured area of the boundary portion UN to the calculation resource assignment unit 114.

In step S211, the calculation resource assignment unit 114 further determines the value of the calculation resource to be assigned to the resolution increasing unit 113 as the second value on the basis of the area of the boundary portion UN that has been measured. The calculation resource assignment unit 114 may determine the second value by increasing the second value as the measured area of the boundary portion UN is larger.

In step S212, the calculation resource assignment unit 114 further assigns a calculation resource to the resolution increasing unit 113 on the basis of the second value determined in step S211.

Since steps S213 to S215 are respectively the same as steps S10 to S12 in FIG. 4, description will be omitted here.

As described above, the subject extraction device 10 according to the first modification further includes the boundary portion measurement unit 115 that measures the area of the boundary portion UN, and the calculation resource assignment unit 114 determines the value of the calculation resource to be assigned to the resolution increasing unit 113 as the second value on the basis of the area of the boundary portion UN, and assigns the calculation resource to the resolution increasing unit 113 on the basis of the determined second value.

According to the present modification, the amount of calculation resources for the resolution increasing unit 113 to judge whether each pixel of the boundary portion UN is the subject portion FG′ is determined on the basis of the size of the area of the boundary portion UN. Since the value of the calculation resource necessary for the judgement processing of the boundary portion UN that consumes the calculation resource can be determined according to the area of the boundary portion UN, it is possible to assign the calculation resource with higher efficiency as compared with a case where the second value is simply determined only by the number of subject portions.

### Second Modification

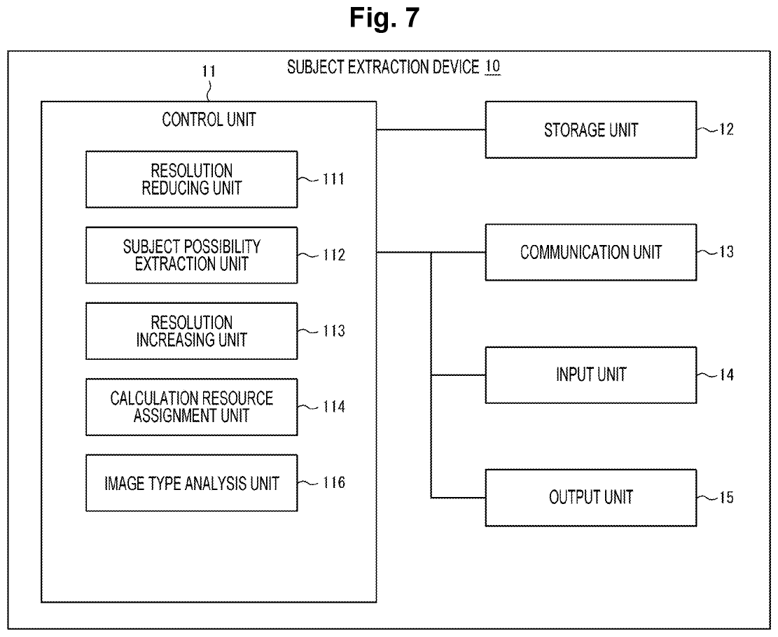

Next, a second modification of the embodiment of the present disclosure will be described. As illustrated in FIG. 7, in the present modification, the control unit 11 further includes an image type analysis unit 116.

The image type analysis unit 116 analyzes the image acquired by the control unit 11 and estimates the type. As the estimation method, an object detection method in a known image analysis technology, a category estimation method using machine learning, or the like may be adopted. In the present modification, the image type analysis unit 116 estimates that the game is a singles game or a doubles game of badminton from the acquired image. The image type that can be estimated by the image type analysis unit 116 is not limited thereto, and may be an image in which any subject such as a person, an animal, a building, or a vehicle appears. The image type analysis unit 116 outputs information indicating a result of the estimation to the calculation resource assignment unit 114.

The calculation resource assignment unit 114 determines the number of subject portions according to the estimated type of the image, and determines the value of the calculation resource to be assigned to the resolution increasing unit 113 as the second value according to the number of subject portions.

For example, when the type of the image estimated by the image type analysis unit 116 is a singles game of badminton, the calculation resource assignment unit 114 determines the number of subject portions as 1, and determines the value “1” as the value of the calculation resource to be assigned to the resolution increasing unit 113 as the second value. For example, when the type of the image estimated by the image type analysis unit 116 is a doubles game of badminton, the calculation resource assignment unit 114 determines the number of subject portions as 2, and determines the value “2” as the value of the calculation resource to be assigned to the resolution increasing unit 113 as the second value.

As similar to the above-described embodiment, the calculation resource assignment unit 114 assigns calculation resources to the subject possibility extraction unit 112 and the resolution increasing unit 113 on the basis of the determined first value and second value.

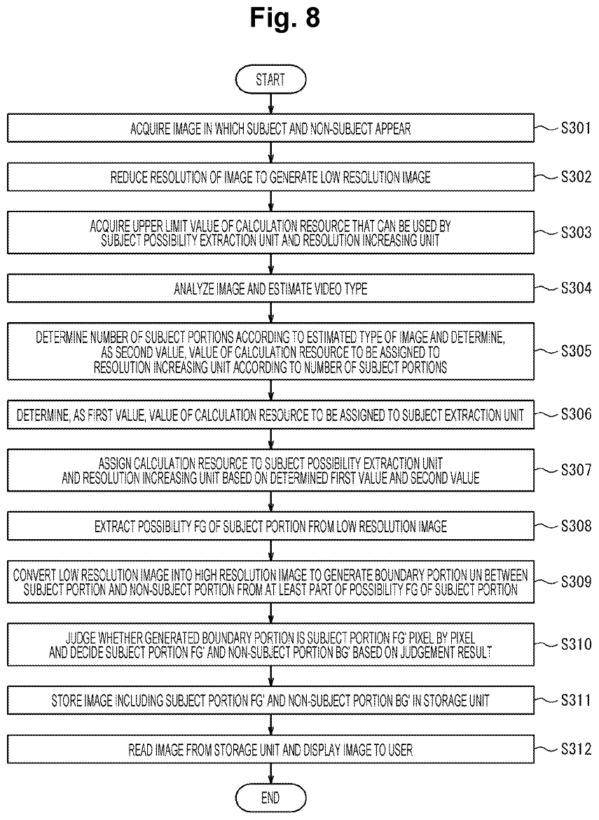

Hereinafter, a difference between the operation of the subject extraction device 10 according to the above-described embodiment and the operation of the subject extraction device 10 according to the present modification will be described with reference to FIG. 8.

Since steps S301 to S303 in FIG. 8 are respectively the same as steps S1 to S3 in FIG. 4 according to the above-described embodiment, description will be omitted here.

In step S304, the image type analysis unit 116 analyzes the image acquired by the control unit 11 and estimates the type. As the estimation method, an object detection method in a known image analysis technology, a category estimation method using machine learning, or the like may be adopted. The image type analysis unit 116 outputs information indicating a result of the estimation to the calculation resource assignment unit 114.

In step S305, the calculation resource assignment unit 114 determines the number of subject portions according to the estimated type of the image, and determines the value of the calculation resource to be assigned to the resolution increasing unit 113 as the second value according to the number of subject portions. For example, when the type of the image estimated by the image type analysis unit 116 is a singles game of badminton, the calculation resource assignment unit 114 determines the number of subject portions as 1, and determines the value “1” as the value of the calculation resource to be assigned to the resolution increasing unit 113 as the second value.

Since steps S306 to S312 in FIG. 8 are respectively the same as steps S6 to S12 in FIG. 4 according to the above-described embodiment, description will be omitted here.

As described above, the subject extraction device 10 according to the second modification further includes the image type analysis unit 116 that analyzes the type of the image, and the calculation resource assignment unit 114 determines the number of subject portions according to the type, and determines the value of the calculation resource to be assigned to the resolution increasing unit 113 as the second value according to the number of subject portions.

According to the present modification, the image type analysis unit 116 can estimate the type of the input image without the user's input, and the calculation resource assignment unit 114 can determine the number of subject portions on the basis of the estimation result. Therefore, the calculation resources can be automatically assigned and processed until the subject portion is extracted after the image is input, and the technology of extracting the subject portion can be improved.

Regarding the above embodiment, the following supplementary notes are further disclosed.

### (Supplementary Note 1)

A subject extraction device including a control unit that
reduces resolution of an image to generate a low resolution image;
extracts possibilities of a subject portion from the low resolution image;
increases resolution of a boundary portion between the subject portion and a non-subject portion among the possibilities of the subject portion, judges whether the boundary portion is the non-subject portion pixel by pixel, and decides the subject portion and the non-subject portion on the basis of a judgement result; and
acquires an upper limit value of a calculation resource that can be used by the extraction of the possibilities of the subject portion and the increase in the resolution, determines a value of the calculation resource to be assigned to the extraction of the possibilities of the subject portion as a first value and a value of the calculation resource to be assigned to the increase in the resolution as a second value such that the values are equal to or less than the upper limit value that has been acquired, and assigns the calculation resource to the extraction of the possibilities of the subject portion and the increase in the resolution on the basis of the first value and the second value that have been determined.

### (Supplementary Note 2)

The subject extraction device according to Supplementary Note 1, wherein the control unit measures an area of the boundary portion, and
determines a value of the calculation resource to be assigned to the increase in the resolution as the second value on the basis of an area of the boundary portion, and assigns the calculation resource to the increase in the resolution on the basis of the second value that has been determined.

### (Supplementary Note 3)

The subject extraction device according to Supplementary Note 1 or 2, wherein the control unit analyzes a type of an image, and
determines the number of the subject portions according to the type, and determines the value of the calculation resource to be assigned to the increase in the resolution as the second value according to the number of the subject portions.

### (Supplementary Note 4)

A subject extraction method performed by a subject extraction device, the method including:
a resolution reducing step of reducing resolution of an image to generate a low resolution image;
a subject possibility extraction step of extracting possibilities of a subject portion from the low resolution image;
a resolution increasing step of increasing resolution of a boundary portion between the subject portion and a non-subject portion among the possibilities of the subject portion, judging whether the boundary portion is the non-subject portion pixel by pixel, and deciding the subject portion and the non-subject portion on the basis of a judgement result; and
a calculation resource assignment step of acquiring an upper limit value of a calculation resource that can be used by the subject possibility extraction step and the resolution increasing step, determining a value of the calculation resource to be assigned to the subject possibility extraction step as a first value and a value of the calculation resource to be assigned to the resolution increasing step as a second value such that the values are equal to or less than the upper limit value that has been acquired, and assigning the calculation resource to the subject possibility extraction step and the resolution increasing step on the basis of the first value and the second value that have been determined.

### (Supplementary Note 5)

The subject extraction method according to Supplementary Note 4, further including a boundary portion measurement step of measuring an area of the boundary portion,
wherein, the calculation resource assignment step further includes a step of determining a value of the calculation resource to be assigned to the resolution increasing step as the second value on the basis of an area of the boundary portion, and a step of assigning the calculation resource to the resolution increasing step on the basis of the second value that has been determined.

### (Supplementary Note 6)

The subject extraction method according to Supplementary Note 4 or 5, further including an image type analysis step of analyzing a type of the image,
wherein the calculation resource assignment step further includes: a step of determining the number of the subject portions according to the type, and a step of determining a value of the calculation resource to be assigned to the resolution increasing step as the second value according to the number of the subject portions.

### (Supplementary Note 7)

A non-transitory computer-readable medium storing a program for causing a computer to function as the subject extraction device according to any one of Supplementary Notes 1 to 3.

### REFERENCE SIGNS LIST

10 Subject extraction device
11 Control unit
12 Storage unit
13 Communication unit
14 Input unit
15 Output unit
111 Resolution reducing unit
112 Subject possibility extraction unit
113 Resolution increasing unit
114 Calculation resource assignment unit
115 Boundary portion measurement unit
116 Image type analysis unit

1. A subject extraction device comprising a processor configured to execute operations comprising:
retrieving a first image as input, wherein the first image is at a first resolution;
generating a second image at a second resolution by reducing the first resolution of the first image to the second resolution;
extracting candidate data of a subject portion from the second image;
increasing a resolution of a boundary portion between the subject portion and a non-subject portion among the candidate data of the subject portion from the second resolution;
determining, in pixel by pixel basis, whether the boundary portion corresponds to the non-subject portion;
determining the subject portion and the non-subject portion based on a result of the determining the boundary portion as the non-subject portion;
obtaining an upper limit value of a calculation resource available for the extracting candidate data operation and the increasing a resolution of the boundary portion operation;
determining a first value of the calculation resource to be assigned to the extracting candidate data operation and a second value of the calculation resource to be assigned to the increasing a resolution of the boundary portion operation, wherein the first and second values are equal to or less than the upper limit value; and
assigning the first value of the calculation resource to the extracting candidate data operation and the second value of the calculation resource to the increasing a resolution of the boundary portion operation.

2. The subject extraction device according to claim 1, the processor further configured to execute operations comprising:
measuring an area of the boundary portion, wherein the obtaining further comprises determining the second value of the calculation resource to be assigned to the increasing a resolution of the boundary portion operation based on the area of the boundary portion; and
assigning the second value of the calculation resource to the increasing a resolution of the boundary portion operation.

3. The subject extraction device according to claim 1, the processor further configured to execute operations comprising:
determining a type of the image,
wherein the obtaining further comprises:
determining the number of the subject portion according to the type, and
determining the second value of the calculation resource to be assigned to the increasing a resolution of the boundary portion operation according to the number of the subject portion.

4. A computer implemented method for extracting a subject, comprising:
retrieving a first image as input, wherein the first image is at a first resolution;
generating a second image at a second resolution by reducing the first resolution of the first image to the second resolution;
extracting candidate data of a subject portion from the second image;
increasing a resolution of a boundary portion between the subject portion and a non-subject portion among the candidate data of the subject portion from the second resolution;
determining, in pixel by pixel basis, whether the boundary portion corresponds to the non-subject portion;
determining the subject portion and the non-subject portion based on a result of the determining the boundary portion as the non-subject portion;
obtaining an upper limit value of a calculation resource available for the extracting candidate data and the increasing a resolution of the boundary portion operation;
determining a first value of the calculation resource to be assigned to the extracting candidate data operation and a second value of the calculation resource to be assigned to the increasing a resolution of the boundary portion operation, wherein resolution increasing step as a second value such that the first and second values are equal to or less than the upper limit value; and
assigning the first value of the calculation resource to the extracting candidate data operation and the second value of the calculation resource to the increasing a resolution of the boundary portion operation.

5. The computer implemented method according to claim 4, the processor further configured to execute operations comprising:
measuring an area of the boundary portion,
wherein the obtaining further comprises determining the second value of the calculation resource to be assigned to the increasing a resolution of the boundary portion operation based on an area of the boundary portion; and
assigning the second value of the calculation resource to the increasing a resolution of the boundary portion operation.

6. The computer implemented method according to claim 4, further comprising:
determining a type of the image,
wherein the obtaining further comprises:
determining the number of the subject portion according to the type, and
determining the second value of the calculation resource to be assigned to the increasing a resolution of the boundary portion operation according to the number of the subject portion.

7. A computer-readable non-transitory recording medium storing a computer-executable program instructions that when executed by a processor cause a computer to execute operations comprising:
retrieving a first image as input, wherein the first image is at a first resolution;
generating a second image at a second resolution by reducing the first resolution of the first image to the second resolution;
extracting candidate data of a subject portion from the second image;
increasing a resolution of a boundary portion between the subject portion and a non-subject portion among the candidate data of the subject portion from the second resolution;
determining, in pixel by pixel basis, whether the boundary portion corresponds to the non-subject portion;
determining the subject portion and the non-subject portion based on a result of the determining the boundary portion as the non-subject portion;
obtaining an upper limit value of a calculation resource available for the extracting candidate data operation and the increasing a resolution of the boundary portion operation;
determining a first value of the calculation resource to be assigned to the extracting candidate data operation and a second value of the calculation resource to be assigned to the increasing a resolution of the boundary portion operation, wherein the first and second values are equal to or less than the upper limit value; and
assigning the first value of the calculation resource to the extracting candidate data operation and the second value of the calculation resource to the increasing a resolution of the boundary portion operation.
